(19) United States
(12) Patent Application Publication
(10) Pub. No.: US 2010/0299035 A1
(43) Pub. Date: Nov. 25, 2010

(54) PARKING BRAKE DEVICE AND METHOD FOR OPERATING SAME

(75) Inventors: Christof Maron, Kelkheim (DE); Bernhard Schmittner, Goldbach (DE); Heinz-Anton Schneider, Niedernhausen (DE); Ralf karsjes, Altmannstein (DE); Lothar Werner, Neunkirchen (DE)

Correspondence Address: RATNERPRESTIA, P.O. BOX 980, VALLEY FORGE, PA, 19482, US

(73) Assignee: Continental Teves AG & Co., oHG, Frankfurt (DE)

(21) Appl. No.: 12/670,480

(22) PCT Filed: Jul. 16, 2008
(86) PCT No.: PCT/EP08/59278

§ 371 Date: Jul. 14, 2010

(30) Foreign Application Priority Data
Jul. 26, 2007 (DE) 10 2007 035 526.4
Jul. 16, 2008 (DE) 10 2008 033 309.3

(51) Int. Cl. F16D 65/34; G06F 19/00; B60T 17/18; B60T 13/74

(52) U.S. Cl. 701/70; 188/106 P

(57) ABSTRACT

A parking brake device for motor vehicles is described, having an operator control element and at least two electromechanical actuators for generating a parking braking force at in each case one wheel of the motor vehicle, and having in each case one wheel actuation unit per electromechanical actuator, and a further control unit. The further control unit is connected here, on the one hand, to the operator control element and, on the other hand, in parallel to each wheel actuation unit via at least one parking brake data bus. The further control unit applies control signals to the wheel actuation units, and a safety element is provided which ensures reliable operation of the parking brake device with wheel control units with, in each case, one microcontroller. The safety element ensures, even in the case of a communication fault in the parking brake data bus, the reliable operation of the wheel actuation units within the parking brake, and the safety element ensures the activation of at least one actuator even in the case of a communication fault in the parking brake data bus of the parking brake device. In addition, a method for operating such a parking brake device is described.

### CROSS REFERENCE TO RELATED APPLICATIONS

This application is the U.S. national phase application of PCT International Application No. PCT/EP2008/059278, filed Jul. 16, 2008, which claims priority to German Patent Application No. 10 2007 035 526.4, filed Jul. 26, 2007 and German Patent Application No. 10 2008 033 309.3, filed Jul. 16, 2008, the contents of such applications being incorporated by reference herein.

### BACKGROUND OF THE INVENTION

1. Field of the Invention

The present invention relates to a parking brake device for motor vehicles having an operator control element and at least two electromechanical actuators for generating a parking braking force at in each case one wheel of the motor vehicle, and having at least one wheel actuation unit and one further control unit. The invention also relates to a method for operating such a parking brake device.

2. Description of Related Art

Parking brake devices for motor vehicles which are activated by electromechanical actuators are known as electrical parking brakes or EPB for short. Such a parking brake has an operator control element, for example a momentary contact switch, which permits the parking brake to be activated with little application of force.

Hitherto, parking brake devices have generally been constructed in the way illustrated schematically in FIG. 1. The parking brake device has a central electronic actuation unit 4 which, on the one hand, is connected to the vehicle control bus 5 and to the operator control element (not illustrated) and, on the other hand, energizes the actuators 1, 2 on the corresponding brake devices independently of one another via the respective voltage supplies 3 and 6. The respective parking brake is correspondingly closed or opened. The failure of an actuator 1, 2 therefore has no effect on the possibility of actuating the respective other actuator 1, 2.

Within the scope of cost optimization there is provision for the central actuation unit for the actuators to be broken up and the functionality of the central actuation unit to be implemented at least partially by means of vehicle control units which are already present in the vehicle and which also carry out other functions.

One possibility for distribution of the central actuation unit of a vehicle brake device is described in document WO 2007/014952 A1, which is incorporated by reference. Each wheel brake which can be activated electromechanically is respectively assigned to a dedicated open-loop and closed-loop control unit.

Another solution is known from document DE 100 06 656 C1, which is incorporated by reference. What is referred to as a BAF control unit (brake assistant function control unit) is provided in the motor vehicle, to which BAF control unit the parking brake request of the driver is transmitted from the operator control element. The BAF control unit also controls one or more of the functions of the electrical stability programme, of the traction controller and of the electrical differential lock. If the vehicle speed is within a specific speed range, the braking means assigned to the parking brake are activated both by the EPB control unit and by the BAF control unit, with braking pressures or braking forces being generated by the BAF control unit as a function of the braking effect achieved by means of the EPB control unit. Below the abovementioned speed range, the parking brake is merely activated by means of the EPB control unit, with the result that this control unit has to be equipped with the full functionality for actuation of the actuator and cost saving in terms of the embodiment of the control devices is not achieved.

In addition, three signal lines are provided in the parking brake device known from DE 100 06 656 C1, wherein the first signal line connects the operator control element and EPB control unit to one another, the second control line connects the operator control element and the BAF control unit to one another, and the third signal line connects the two control units to one another. A parking brake request which is signaled by activation of the operator control element is transmitted to the BAF control unit from the EPB control unit via the third signal line. Since each control unit actuates an electromechanical actuator, satisfactory operation of the parking brake device is no longer possible in the event of a failure of one of the two control units.

When the functional scope of the central actuation unit is implemented in a control unit of the motor vehicle which also carries out other functions, there is a problem that the electromechanical actuator has to be provided with a controllable voltage supply. If the control unit which also carries out other functions is too far from the actuator to be controlled, an optimum voltage supply of the actuator is thus no longer possible in an unrestricted way owing to the large losses along the line path.

The distribution of the functionality of the central actuation unit is therefore provided in such a way that a simplified logic functional scope of the central actuation unit is exported to vehicle control units which also carry out other functions, and that a considerable proportion of the actuation logic of the actuators, in particular the control of the voltage supply, is exported in what is referred to as a wheel actuation unit (referred to below as RCU) which is arranged in the spatial proximity of the actuators.

The wheel electronics, accommodated in the wheel actuation unit, for electromechanical actuators of parking brakes are composed of power electronics and an open-loop and closed-loop control unit. The wheel actuation unit controls and switches the electrical energy supplied to the electromechanical actuators, on the one hand, and causes processing of the supplied signals and generation of simple new signals to take place, on the other. One or more microcontrollers are provided for the processing of signals and data and for the actual voltage control of the individual actuators. The combination of an electromechanical actuator and wheel electronics is also referred to as a smart actuator.

Since the parking brake constitutes a device which is central in terms of the safety of the motor vehicle and of the vehicle occupants, such distribution of the actuator control requires partial activation of the parking brake to be ensured even in the event of faults in the data transmission or the voltage supply of a smart actuator. In the parking brake device according to FIG. 1, it is also possible, for example in the event of a fault in an actuator, still to actuate the respective other actuator.

For the operation of a travelling vehicle, specific malfunctions of an individual actuator may be critical for safety. In particular the undesired activation of an individual actuator during travel, which could occur, for example, due to a simple fault in a single microcontroller of a smart actuator, is a case in point. In order to avoid this fault, a second microcontroller can be provided as redundancy in the smart actuator. However, this solution is very costly.

Alternatively, a switch, which is switched by an actuation unit outside the smart actuator and therefore only permits actuation of the actuators and consequently application of the parking brake, can be provided in the smart actuator. This solution is also disadvantageous.

### SUMMARY OF THE INVENTION

An object of the present invention is accordingly to provide a parking brake device for motor vehicles in which the activation of at least one actuator in the event of a fault is possible at any time, as is also implemented in the known system according to FIG. 1. The object is also to specify a corresponding method for operating a parking brake device.

At least one object of the invention is achieved by means of a parking brake device in which each electromechanical actuator is respectively provided with a wheel actuation unit, wherein the further control unit (also referred to as ECU) is connected, on the one hand, to the operator control element and, on the other hand, in parallel to each wheel actuation unit via at least one parking brake data bus, wherein the further control unit applies control signals to the wheel actuation units, and wherein means are provided which ensure the activation of at least one actuator even in the event of a communication fault in the system of the parking brake device. Each actuator is preferably connected here to a separate wheel actuation unit which is active only for this actuator.

As a result of the connection of the controllers which is provided in the parking brake device according to aspects of the invention and the means for activating at least one actuator, reliable activation of the parking brake device can be ensured even in the event of a fault. In this case, the functionality which comprises the further control unit is integrated into a controller, which also contains other control functions of the motor vehicle, for example the ESP (=Electronic Stability Programme) controller.

In a first exemplary embodiment of the invention, at least one safety data bus is provided as means for ensuring the actuator activation, which safety data bus connects the further control unit to each wheel actuation unit (RCU) in parallel with the parking brake data bus. In the event of a failure of the parking brake data bus, it is therefore ensured that actuation of the actuators can continue to take place by means of the further control unit (ECU) via the safety data bus.

In a second, alternative embodiment, at least one control/emergency control line is provided as means for ensuring the actuator activation, which control/emergency control line connects the further control unit (ECU) to a wheel actuation unit (RCU) in parallel with the parking brake data bus. Two control/emergency control lines are preferably provided, wherein each control/emergency control line connects the further control unit to one wheel actuation unit in each case.

The control/emergency control line serves in the normal operating case as a logic protection of the parking brake data bus and of the simple microcontroller which is contained in each of the wheel actuation units. For the event of a fault in the parking brake data bus, the signals which are transmitted via the control/emergency control line serve additionally as an input value into a logic actuator enable circuit which is provided in the respective wheel actuation unit. This permits the parking brake device to operate reliably, each wheel actuation unit requiring only a single microcontroller here.

In the event of a communication fault between a further control unit and a wheel actuation unit, a simple logic data protocol is applied to this control/emergency control line, which data protocol permits the individual actuators/wheel actuation units to be actuated without the connection to the parking brake data bus.

This solution is also a variant which is more cost-effective than the first exemplary embodiment, since it is not necessary to provide a further data bus but rather merely a single electrical connecting line.

The further control unit preferably has means which, in an emergency mode, preferably in the event of failure of the parking brake data bus, transmit a safety signal sequence (signal code) to the wheel actuation unit via the control/emergency control line. In the event of faulty operation, a single logic signal (safety signal sequence) is accordingly generated, which logic signal as it were signals (triggers) the activation of the respective actuator by the wheel actuation unit. The subsequent high signal on the control/emergency control line (for example a defined current level) serves as continuous energization for a discrete time period, for example approximately 2 seconds, for enabling the respective actuator, with the result that the microcontroller of the wheel actuation unit directly brings about the actuation of the associated parking brake. The activation of the actuator by the wheel actuation unit is therefore carried out after the reception of the high signal at the input of the respective wheel actuation unit.

For this purpose, in one preferred exemplary embodiment of the parking brake device according to aspects of the invention, each wheel actuation unit has means which receive the safety signal sequence at the input of the control/emergency control line and subsequently verify said safety signal sequence and permit actuator activation in the event of a positive verification result.

In order to prevent tampering interventions into the parking brake device from the outside, the simple logic data protocol (safety signal sequence) can also be selected such that the logic is subjected to encoding which can vary over time, i.e. is chronically variable. For example, the code can be selected as a function of the system time, generated by means of a random generator or communicated via the parking brake data bus (if the latter is still operating correctly). In the last-mentioned case, in the event of a failure of the parking brake data bus the safety signal sequence is selected such that it corresponds to the signal sequence which was last communicated before the failure.

In a further preferred exemplary embodiment of the invention, each wheel actuation unit has means which generate a confirmation signal sequence (confirmation signal code) after the activation of the actuator ends, wherein the confirmation signal sequence can be transmitted to the further control unit via the respective control/emergency control line. The driver of the motor vehicle can be informed by means of the confirmation signal sequence, or other functionalities of the motor vehicle by means of the successful activation of the parking brake.

In order to be able to generate the described safety signal sequences, the further control unit and, if appropriate, each wheel control unit preferably have means for generating signal sequences of an electrical signal.

At least one object of the invention is also achieved by means of a method for operating a parking brake device, which method carries out the following steps:
monitoring of the communication in the system of the parking brake device and initiation of the emergency mode if a communication fault is detected, for example on a parking brake data bus and
use of the means for activating at least one actuator in the emergency mode if the driver activates the operator control element and/or the motor vehicle is stationary.

The method according to aspects of the invention ensures that the parking brake device maintains its functionality, i.e. at least one actuator can be activated, even if a communication fault occurs in the system.

The emergency mode preferably comprises the transfer and execution of the communication between the further control unit and each wheel actuation unit by means of the safety data bus. This emergency operation can be carried out if a second data bus specifically the safety data bus, is provided in parallel with the parking brake data bus.

Alternatively, the emergency mode comprises the transfer and execution of the communication between the further control unit (ECU) and each wheel actuation unit by means of the at least one control/emergency control line. This is a particularly simple method which can be carried out if at least one control/emergency control line, which connects each wheel actuation unit to the further control unit, is provided.

In the last-mentioned case, if the operator control element is actuated by the driver and/or the motor vehicle is stationary, the further control unit firstly generates a safety signal sequence and subsequently generates a high signal over a specific, permanently predefined time period, preferably over at least approximately 2 seconds, and said safety signal sequence is transmitted to the respective wheel actuation unit via the at least one control/emergency control line. As a result of this combination of the generated signals and signals which are transmitted to the wheel actuation unit, the actuator activation is, on the one hand, initiated (by means of the safety signal sequence) and subsequently also made possible (by means of the high signal).

In a preferred exemplary embodiment, after reception of the safety signal sequence by the input of the user line each wheel actuation unit verifies said safety signal sequence and permits actuator activation in the event of a positive verification result, which is then subsequently made possible by means of the high signal.

It is also preferred if the wheel actuation unit generates a signal sequence after the activation of the respective actuator ends, which signal sequence is transmitted to the further control unit via the at least one control/emergency control line and constitutes confirmation of the actuator activation. As a result, the driver can also be provided with feedback about the actuator activation and ultimately about the activation of the parking brake.

Further features, advantages and application possibilities of the present invention emerge from the following description of exemplary embodiments of the parking brake devices according to aspects of the invention and their method of operation with reference to FIGS. 2 and 3. Here, all the features which are described and/or illustrated figuratively form in themselves or in any desired combination the subject matter of the present invention.

### BRIEF DESCRIPTION OF THE DRAWINGS

FIG. 1 shows a parking brake device according to the prior art,

FIG. 2 shows a first embodiment of a parking brake device according to aspects of the invention, and

FIG. 3 shows a second embodiment of a parking brake device according to aspects of the invention.

### DETAILED DESCRIPTION OF THE PREFERRED EMBODIMENTS

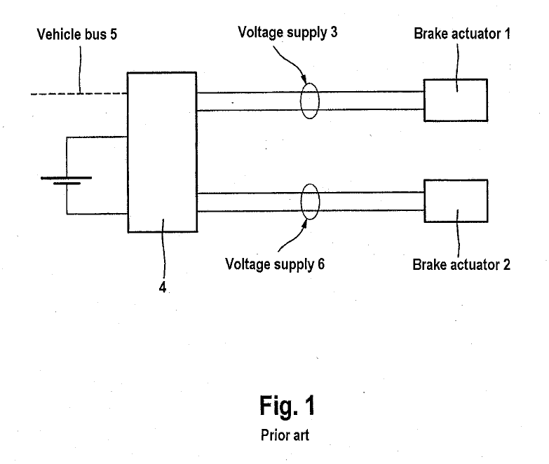

In FIG. 1, the brake actuator 1 and braking actuator 2, which each serve to generate a parking braking force at a wheel of the motor vehicle, are connected in parallel to a central control unit 4 for the parking brake device of the motor vehicle via the voltage supply lines 3 and 6. This central control unit 4 is connected via the vehicle bus 5 to an operator control element which is not illustrated.

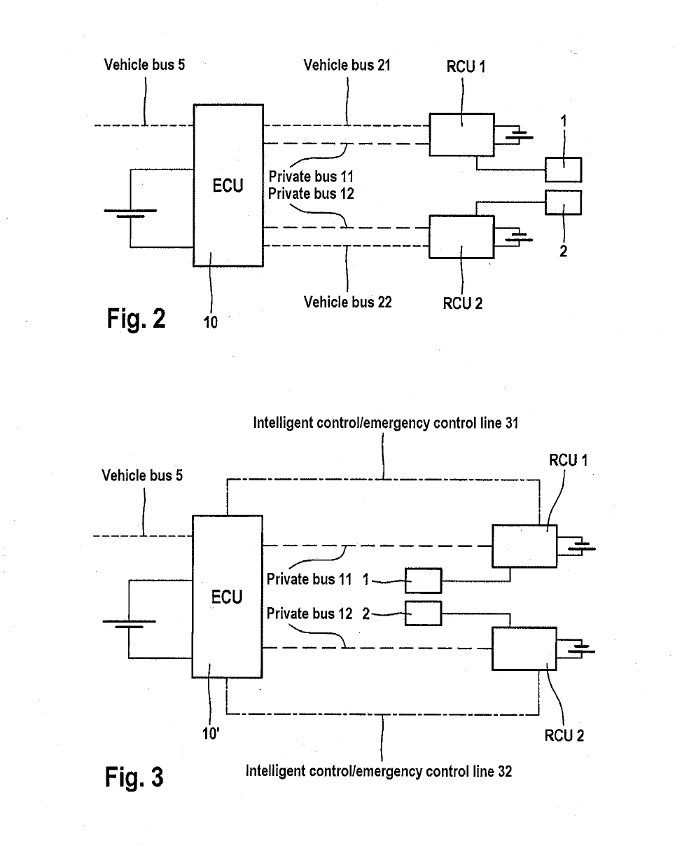

In contrast, the parking brake device according to aspects of the invention which is illustrated in FIG. 2 has in each case a wheel actuation unit RCU1, RCU2 for each actuator 1, 2. The wheel actuation units RCU1 and RCU2 each contain essentially one or more microprocessors for processing the received signals and for generating signals, as well as power electronics which serve to energize the actuator 1 or 2 which is respectively connected to the wheel actuation unit RCU1, RCU2.

In addition, a simple logical functional scope of the central control unit according to the prior art, which contains the sensing of the driver's request and the detection of the vehicle speed, is exported in the form of a further control unit (ECU) 10, which can be integrated into other vehicle control units.

The further control unit 10 is connected via, in each case, one parking brake data bus (private bus) 11 or 12 to a wheel actuation unit RCU1 or RCU2. The connections between the further control unit 10 and the wheel actuation units RCU1 and RCU2, respectively, run parallel to one another.

Alternatively, a single parking brake data bus can also be provided instead of the two individual parking brake data buses 11 and 12, which single data bus contains both parallel connections between RCU1 or RCU2 and ECU 10. For this purpose, only a single transceiver for feeding the bus would be necessary in the further control unit 10 instead of two for the two parking brake data buses 11 and 12.

In addition, in each case one safety data bus (vehicle bus 21 or 22), which runs in parallel with the parking brake data buses 11, 12 and connects in each case one wheel actuation unit RCU1 or RCU2 to the further control unit 10, is provided for each wheel actuation unit RCU1 and RCU2.

If a parking brake data bus 11 or 12 or else both parking brake data buses fail, the communication between the further control unit 10 and each actuation unit RCU1 or RCU2 can take place via the respective safety data bus 21 and/or 22, and a confirmation of the actuators 1, 2 is ensured, for example when the driver expresses a parking braking request by means of the operator control element (not illustrated) and/or the vehicle is stationary. The operator control element is connected here to the further control unit 10 via the vehicle bus 5. The information that the vehicle is stationary can be acquired, for example, by measuring the wheel speed. The processing of the corresponding data for this can take place, for example, in the further control unit 10.

The further exemplary embodiment of an inventive parking brake device which is illustrated in FIG. 3 has two intelligent control/emergency control lines 31, 32 (instead of the vehicle buses 21 and 22) as means for ensuring the actuator activation in the event of a communication fault. The control/emergency control lines 31, 32 each form a simple electrical connection between the further control unit 10′ and RCU1 and RCU2, respectively, wherein the control/emergency control lines 31, 32 run in parallel with one another and respectively parallel with the respective parking brake data bus (private bus) 11, 12.

If the parking brake data bus 11 and/or 12 then fails, this state is perceived both by the further control unit 10′ and by the wheel actuation units RCU1 and/or RCU2, since the data bus communication is no longer operating without faults. In this situation, the “emergency enable” (emergency mode) operating state is switched on. If the vehicle is stationary (information about the lack of movement of the vehicle can be passed on, for example, via the vehicle bus 5 to the further control unit 10′ or, as described above, can be acquired by means of the control unit 10′), the further control unit 10′ generates a previously defined safety signal sequence when the operator control element is activated by the driver (EPB enquiry), and said further control unit 10′ transmits said safety signal sequence to the respective wheel actuation unit RCU1 and/or RCU2 via the control/emergency control line 31 and/or 32. The wheel actuation unit RCU1 and/or RCU2 receive/receives the safety signal sequence at its respective input and verify/verifies it. In the event of a positive result of the verification, an enable instruction is passed on to the respective actuators 1 and/or 2. After the enable instruction, the respective actuator 1, 2 is energized if, after verification of the safety signal sequence over a relatively long time, preferably 2 seconds, a high signal is transmitted to the respective wheel actuation unit 1 or 2 via the respective intelligent control/emergency control line 31 or 32.

The safety signal sequence can preferably be in the frequency range between approximately 100 Hz up to approximately 1 kHz.

The safety signal sequence (safety code) can be protected against theft by configuring the safety signal sequence as a function of the system time or using a random generator to generate the safety signal sequence. In addition, the safety signal sequence can also be communicated to the wheel actuation unit 1 and/or 2 via the parking brake data bus. In the case of the “emergency enable” (emergency mode), the safety code which was last communicated via the parking brake data bus is then valid.

1-15. (canceled)

16. Parking brake device for motor vehicles having an operator control element and at least two electromechanical actuators for generating a parking brake force, in each case an actuator is respectively provided on a wheel of the motor vehicle, and having at least one wheel control unit and one further control unit, wherein each electromechanical actuator is respectively provided with a wheel actuation unit, wherein the further control unit is connected, on the one hand, to the operator control element and, on the other hand, in parallel to each wheel actuation unit via at least one parking brake data bus, wherein the further control unit applies control signals to the wheel actuation units, and wherein means are provided which ensure the activation of at least one actuator even in the case of a communication fault in the system of the parking brake device.

17. Parking brake device according to claim 16, wherein at least one safety data bus is provided as means for ensuring the actuator activation, which safety data bus connects the further control unit to each wheel actuation unit in parallel with the parking brake data bus.

18. Parking brake device according to claim 16, wherein at least one control/emergency control line is provided as means for ensuring the actuator activation, which control/emergency control line connects the further control unit to a wheel actuation unit in parallel with the parking brake data bus.

19. Parking brake device according to claim 18, wherein the further control unit has means which, in an emergency mode, generate a safety signal sequence and/or a high signal over a specific, permanently predefined time period, wherein the safety signal sequence and/or the high signal can be transmitted to the respective wheel actuation unit via the control/emergency control line.

20. Parking brake device according to claim 19, wherein the predefined time period is over at least approximately 2 seconds.

21. Parking brake device according to claim 19, wherein each wheel actuation unit has means which receive the safety signal sequence at the input of the control/emergency control line and subsequently verify said safety signal sequence and permit actuator activation in the event of a positive verification result.

22. Parking brake device according to claim 21, wherein the safety signal sequence is variable.

23. Parking brake device according to claim 19, wherein the activation of the actuator is carried out by the wheel actuation unit after reception of the high signal at the input of the respective wheel actuation unit.

24. Parking brake device according to claim 18, wherein each wheel actuation unit has means which generate a confirmation signal sequence after the activation of the actuator ends, wherein the confirmation signal sequence can be transmitted to the further control unit via the respective control/emergency control line.

25. Parking brake device according to claim 18, wherein the further control unit and, if appropriate, each wheel control unit have means for generating an electrical signal.

26. Method for operating a parking brake device according to claim 16, comprising the following steps:
monitoring of the communication in the system of the parking brake device and initiation of the emergency mode if a communication fault is detected, and
use of the means for activating at least one actuator in the emergency mode if the driver activates the operator control element and/or the motor vehicle is stationary.

27. Method according to claim 26, wherein the emergency mode comprises the transfer and execution of the communication between the further control unit and each wheel actuation unit by means of the safety data bus.

28. Method according to claim 26, wherein the emergency mode comprises the transfer and execution of the communication between the further control unit and each wheel actuation unit by means of the at least one control/emergency control line.

29. Method according to claim 28, wherein if the operator control element is activated by the driver and the vehicle operating state permits closing of the parking brake, the further control unit firstly generates a safety signal sequence and subsequently generates a high signal over a specific, permanently predefined time period, and said safety signal sequence is transmitted to the respective wheel actuation unit via the at least one control/emergency control line.

30. Method according to claim 29, wherein the predefined time period is over at least approximately 2 seconds.

31. Method according to claim 29, wherein after reception of the safety signal sequence by the input of the control/emergency control line each wheel actuation unit verifies said safety signal sequence and permits actuator activation in the event of a positive verification result.

32. Method according to claim 28, wherein each wheel actuation unit generates a signal sequence after the activation of the respective actuator ends, which signal sequence is transmitted to the further control unit via the at least one control/emergency control line and constitutes confirmation of the actuator activation.
